(19) United States
(12) Patent Application Publication
(10) Pub. No.: US 2023/0274386 A1
(43) Pub. Date: Aug. 31, 2023

(54) SYSTEMS AND METHODS FOR DIGITAL DISPLAY STABILIZATION

(71) Applicant: Ford Global Technologies, LLC, Dearborn, MI (US)

(72) Inventors: David Herman, West Bloomfield, MI (US); Yashanshu Jain, Dearborn, MI (US)

(73) Assignee: Ford Global Technologies, LLC, Dearborn, MI (US)

(21) Appl. No.: 17/652,756

(22) Filed: Feb. 28, 2022

(51) Int. Cl. G06T 3/00; G06T 7/20; G06T 7/70; G06V 40/18

(52) U.S. Cl. CPC G06T 3/0093; G06T 7/20; G06T 7/70; G06V 40/18; G06T 2207/30248

(57) ABSTRACT

The disclosure is generally directed to a vehicle, systems and methods for display stabilization including receiving a plurality of image data from sensors in a vehicle, receiving a plurality of measurements of road excitations from sensors in the vehicle, estimating a three-dimensional position of a driver or a passengers eyes based on the received plurality of image data, receiving apriori data from high definition maps, recorded accelerations of the vehicle, and stored data via a controller area network (CAN) bus, determining a prediction of motion of a display in the vehicle based on a fusion of the received image data, the plurality of measurements of road excitations and the apriori data, modeling the prediction of motion of the display in a convolutional neural network to form an initial estimate of a display stabilization position, and display computationally corrected images on the display based on the display stabilization position.

### BACKGROUND

Vehicle rear view mirrors often vibrate due to vehicle vibrations. Other components subject to vibration include cameras or network-connected mounted displays. For example, a rear view mirror may have additive vibrations from camera and mirror mounts. Vibrations may be exacerbated in vehicles with sport tuned suspensions. Vibrations may be annoying to the driver, especially when using applications or when using larger/higher resolution screens.

It is desirable to provide solutions to stabilize displays without requiring additional modifications to the physical display.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system that includes a in accordance with an embodiment of the disclosure.

FIG. 2 illustrates some example functional blocks that may be included in an on-board computer in a vehicle in accordance with an embodiment of the disclosure.

FIG. 3 illustrates a flow diagram of a method in accordance with an embodiment of the disclosure.

### DETAILED DESCRIPTION

In terms of a general overview, this disclosure is generally directed to systems and methods for stabilizing a display in a vehicle. The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternative implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

It should also be understood that the word “example” as used herein is intended to be non-exclusionary and non-limiting in nature. Furthermore, certain words and phrases that are used herein should be interpreted as referring to various objects and actions that are generally understood in various forms and equivalencies by persons of ordinary skill in the art. For example, the word “application” or the phrase “software application” as used herein with respect to a mobile device such as a smartphone, refers to code (software code, typically) that is installed in the mobile device. The code may be launched and operated via a human machine interface (HMI) such as a touchscreen. The word “action” may be used interchangeably with words such as “operation” and “maneuver” in the disclosure. The word “maneuvering” may be used interchangeably with the word “controlling” in some instances. The word “vehicle” as used in this disclosure can pertain to any one of various types of vehicles such as cars, vans, sports utility vehicles, trucks, electric vehicles, gasoline vehicles, hybrid vehicles, and autonomous vehicles. Phrases such as “automated vehicle,” “autonomous vehicle,” and “partially-autonomous vehicle” as used in this disclosure generally refer to a vehicle that can perform at least some operations without a driver being seated in the vehicle.

The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment issues. The level of human intervention is very low. Level 5 (L5) vehicles are fully autonomous vehicles that do not involve human participation.

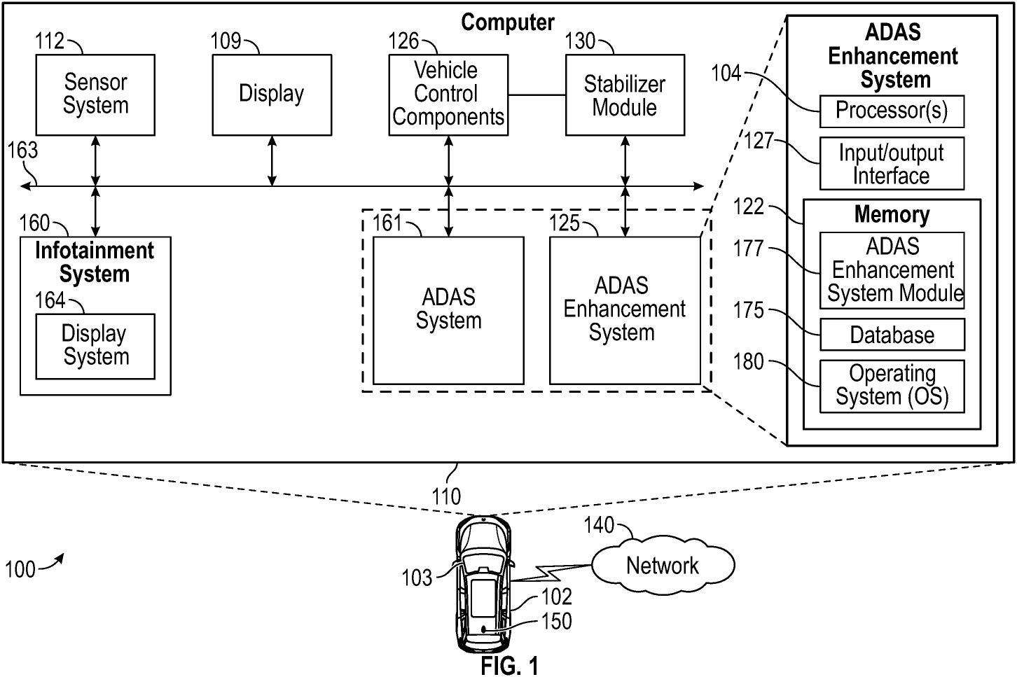

FIG. 1 illustrates an example system 100 that includes a vehicle 102. The vehicle 102 may be one of various types of vehicles with a chassis and may be a gasoline powered vehicle, an electric vehicle, a hybrid electric vehicle, or an autonomous vehicle, that is configured as a Level 2 or higher automated or semi-automated vehicle. The system 100 may be implemented in a variety of ways and can include various types of devices. For example, the example system 100 can include some components that are a part of the vehicle 102. The components that can be a part of the vehicle 102 can include a vehicle on-board computer 110, and a sensor system 112 coupled to cameras and display 109. Thus, on-board computer 110 may be coupled to vehicle 102, the on-board computer including at least a memory and a processor, such as memory 122 and processor 104 coupled to the memory wherein the processor 104 is configured to determine corrections to stabilize display 109.

The vehicle on-board computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in a blind spot, etc.).

The vehicle computer on-board 110, in one or more embodiments, may be used to support features such as passive keyless operations, remotely-controlled vehicle maneuvering operations, and remote vehicle monitoring operations.

The vehicle on-board computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in a blind spot, etc.). In one or more embodiments, vehicle on-board computer 110 may enable a self-driving car or provide driver assistance. Thus, vehicle on-board computer 110 may further include an Advanced Driver-Assistance System (“ADAS”) enhancement system 125 and ADAS System 161, which can be coupled to different components of vehicle 102 through a Controller Area Network (CAN) bus 163. which is shown to further include, as one embodiment, the various components of the vehicle 102 that may be controlled, activated, and/or operated by the vehicle by the ADAS enhancement system 125. In one implementation, the ADAS enhancement system 125 can be an independent device (enclosed in an enclosure, for example). In another implementation, some or all components of the ADAS enhancement system 125 can be housed, merged, or can share functionality, with vehicle on-board computer 110. For example, an integrated unit that combines the functionality of the ADAS enhancement system 125 can be operated by a single processor and a single memory device. In the illustrated example configuration, the ADAS enhancement system 125 includes the processor 104, an input/output interface 127, and memory 122, ADAS Enhancement System Module 177, database 175 and operating system 180. The input/output interface 127 is configured to provide communications between the ADAS enhancement system 125 and other components such as the sensors 150 the vehicle control components and any infotainment system, if present. As shown ADAS Enhancement System can include processor 104, input/output interface 127, and memory 122, which is one example of a non-transitory computer-readable medium, which may be used to store an operating system (OS) 180, a database 175, and various code modules such as an ADAS enhancement system module 177. The modules, including ADAS enhancement system module 177, may be provided in the form of computer-executable instructions that can be executed by processor 104 for performing various operations in accordance with the disclosure.

Vehicle on-board computer 110 may receive inputs from a Controller Area Network (CAN) bus 163, which may be a central controller that monitors vehicle 102 systems and sensors 150. CAN bus 163 may connect all communications between modules and receive inputs from accelerometers, such as accelerometers 103 located about vehicle 102. As one of skill in the art with the benefit of this disclosure will appreciate, the CAN bus and system modules connected thereto may serve as a port for sending and receiving updates, images from sensors, and stored data including apriori data to modules connected to the CAN bus. As one of skill in art will appreciated that the CAN bus is a message-based protocol that is capable of connecting sensors 150 across vehicle 102 network. A high-speed CAN network is capable of providing data to and from sensors 150, which may include cameras.

In one or more embodiments, vehicle sensors may produce data capable or dynamic calibration such that when vibrations applied to vehicle 102 may be recorded while vibrations occur to vehicle 102. Since vibrations may cause displays to displace from an original setting, calibrations values and an adjustment model mased on data received over CAN bus may be received by on-board computer and display stabilization module to adjust data from different vehicle sensors 150 while vehicle 102 is in motion, such as road vibrations, pot holes and the like. Vehicle sensors used to measure vibration may measure vibration directly such a strain gages, accelerometers, and the like. Other sensors may measure values tightly correlated with vibration such as engine revolution per minute (RPM) and the like. Sensors may be mounted at the point of the camera, display, mirror, or somewhere else on the vehicle. Sensors may detect road surface inputs exterior to the vehicle, e.g., forward looking camera detection of topographic geometry of pot holes. Sensors such as camera may detect their motion due to vibration by studying their output, other vehicle sensor output used to predict another sensor’s output (e.g. engine RPM vibrational affect on camera mount vibration), or some combination thereof.

As one of skill in the art with the benefit of the present disclosure will appreciate, fusion is the combining of data from different sources so that the resulting data has less uncertainty statistically than if data from each source were individually applied to make a determination. for example, a unified model of a position of using stabilization module may involve fusing sensor data. In one or more embodiments, a Kalman filter, a central limit theorem, Bayesian networks, Dempster-Shafer, Gradient Boosted Trees (GBT), or other machine-learning algorithms applicable for convolutional neural networks and the like may apply to fuse the data received from different sensors and from apriori data stored from prior recordings and/or stored time-sensitive data. For example, the fusion of multiple time series of data may provide additional positions of predictive statistical behavior of a display, such as a rearview mirror, a computer display showing a mapping for vehicle 102, or a display for passengers illustrating entertainment and the like. In another example, an instrumented test vehicle may be used to record the exact motion of a vehicle display or mirror in which production vehicle sensors may be used as input into a model to predict the present or future vibration of the display or mirror. In one or more embodiments, the display may be a floating type display such as a surround view display, a three-dimensional display or the like.

In one or more embodiments, vehicle 102 and on-board computer 110 includes instructions performed by a processor that determine a calibration value, or a plurality of calibrations values based on a fusion of different sensor-based data and apriori data stored via CAN bus or in a database such as database 175 or the like.

In one or more embodiments, network 140 may provide further data. For example, a network may provide or load calibration values for computer 110 before or after the vehicle is sold as new. Calibration values may then be adjusted based on stabilizer module 130, based on sensor data and fusion of sensor data with other accelerometer data, vibrations and the like. For example if an adjustment alters coefficients to machine learning algorithms the stabilizer module may solve equations using new coefficients based on new data, such as time series data of the like. For example different calibration values may serve as weights such that stabilizer module operates on a preset sequence of known vibratory data collected or received over network 140. As one of skill in the art will appreciate, some vehicles have interior monitoring cameras with prior knowledge of the vehicle geometry and can determine light sources, such as displays.

In one or more embodiments, communications network 140 includes a cellular or Wi-Fi communication link enabling vehicle 102 to communicate with network 140, which may include a cloud-based network or source for transferring data in accordance with this disclosure.

Vehicle 102 sensors 150 may include a set of nodes and/or sensors such as radars mounted upon vehicle 102 in a manner that allows the vehicle on-board computer 110 to communicate with devices and collect data. Examples of may include sensors, radars and/or emitters capable of detecting objects, distances such as ultrasonic radar, LiDAR, cameras and the like. In one or more embodiments, sensors/cameras may further include one or more of Bluetooth®-enabled sensors, or Bluetooth® low energy (BLE)-enabled sensors, wheel speed sensors, accelerometers 103, rate sensors, GPS sensors, and steering wheel sensors.

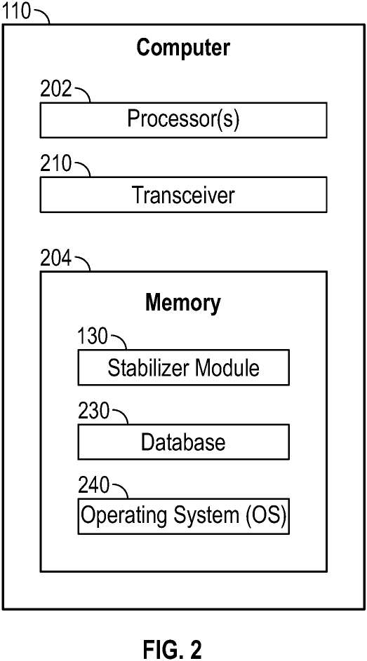

Referring now to FIG. 2, vehicle on-board computer 110 is shown in an alternate configuration to execute various operations in accordance with one or more embodiments.

As shown, in one embodiment, on-board computer 110 includes components such as processor 202, transceiver 210, and memory 204, which is one example of a non-transitory computer-readable medium, may be used to store the operating system (OS) 240, database 230, and various modules such as display stabilization module 130. One or more modules in the form of computer-executable instructions may be executed by the processor 210 for performing various operations in accordance with the disclosure. More particularly, display stabilization module 130 may be executed by the processor 210 in accordance with the disclosure, for determining the corrections necessary to stabilize display 109.

Referring back to FIG. 1, vehicle 102 includes display 109 which is coupled to receive signals from display stabilization module 130. In broad terms, according to embodiments, module 130 receives inputs from accelerometers, wheel sensors, and eye movements of a driver and determines a stabilization correction for display 109.

As shown on FIG. 1, sensors 150 coupled to vehicle 102 include camera(s). In one or more embodiments, the data received camera(s) 150 may be provided to display stabilization module 130 to determine a display stabilization.

In one or more embodiments stabilizer module 130 receives a plurality of inputs to stabilize a display in vehicle 102. For example the plurality of techniques may be within stabilizer module 130. In one embodiment, stabilizer module 130 receives estimations of camera motion based on measured vehicle accelerations. Estimations of camera motion may include analytical models of a camera mount and analytical models of vehicle 102.

For example, stabilizer module 130 may include fusion architecture for applying different types of sensor data fusion methods such as the Kalman filter model and other data driven approaches. Thus, stabilizer module 130 fuses complementary sensors 150 to better capture the motion of road objects.

Stabilizer module 130 may also receive estimated display motion under varying accelerations of vehicle 102.

Stabilizer module 130 may further receive gaze stabilization data to stabilize a display. Stabilizer module may further receive confidence of motion estimates for accuracy of stabilization outcomes. For example, under some scenarios, accuracy of head position maybe higher or lower as compared to the location of the rearview mirror of a vehicle. While driving, a vehicle can use different sensors to detect and predict vehicle accelerations that would affect camera, display, and driver eye gaze. Vehicle acceleration prediction can be used to computationally transform the image overtime to minimize the impact of vibration.

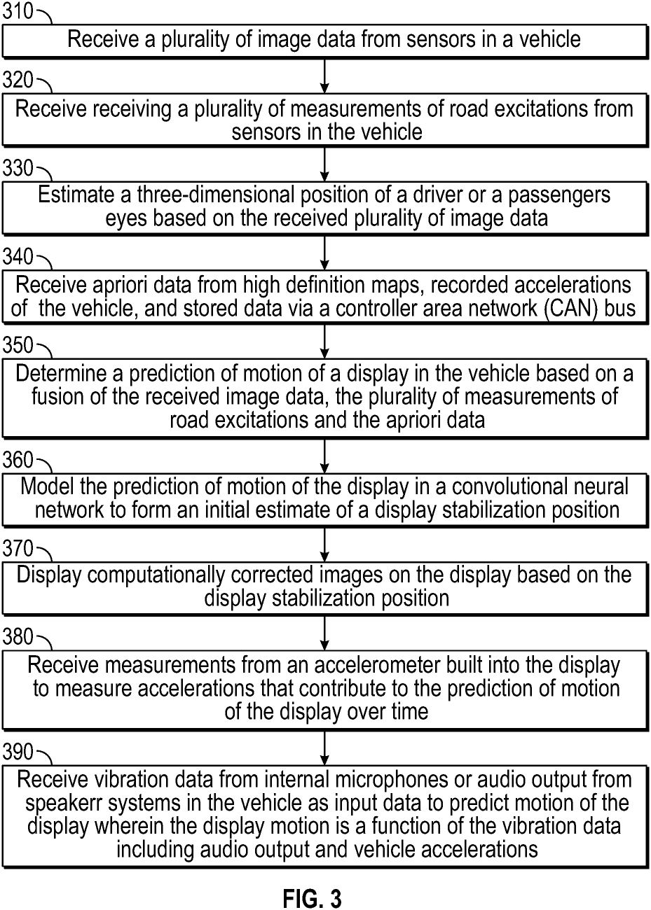

Referring now to FIG. 3 a flow diagram illustrates a method according to an embodiment. As shown, block 310 provides for receiving a plurality of image data from sensors in a vehicle. For example, sensors 150 may provide data to stabilizer module 130.

Block 320 provides for receiving a plurality of measurements of road excitations from sensors in the vehicle. For example, sensors 150 and accelerometer 103 may provide data to stabilizer module 130.

Block 330 provides for estimating a three-dimensional position of a driver or a passengers eyes based on the received plurality of image data. For example, cameras directed at a driver or sensors 150 may include cameras directed at either the driver or a passenger. The data could include video of a passenger in a back seat watching a display that needs stabilization, or the data could include video data of a driver looking at a rearview mirror.

Block 340 provides for receiving apriori data from high definition maps, recorded accelerations of the vehicle, and stored data via a controller area network (CAN) bus. For example, CAN bus 163 may have access to high definition maps stored in a database, such as database 230 or the like, and other stored data received from sensors, accelerometers, wheel sensors and other sensors 150.

Block 350 provides for determining a prediction of motion of a display in the vehicle based on a fusion of the received image data, the plurality of measurements of road excitations and the apriori data. For example, stabilizer module 130 may determine a prediction of motion of a rearview mirror or an entertainment display based on the fusion of the data as described above using Kalman filters or the like. The apriori data may include configuration data, calibration data from a manufacturer or received over network 140 or stored data from collected sensor data and the like.

Block 360 provides for modeling the prediction of motion of the display in a convolutional neural network to form an initial estimate of a display stabilization position. For example, a convolutional neural network can be based on images received from sensors and cameras 150 and provided to stabilizer module 130. Stabilizer module 130 may then form a neural network based on the images and sensor data. The neural network would then be available for fusing new sensor data.

Block 370 provides for displaying computationally corrected images on the display based on the display stabilization position. For example, vehicle 102 may include several displays such as a rearview mirror, an infotainment display, a display for passengers to enjoy a video, all generically shown as display 109 in FIG. 1. The computationally corrected images corrected via stabilizer module 130 may be located within the display requiring correction. For example, in one embodiment, stabilizer module 130 may be located within each display depending on system requirements and processor availability.

In one embodiment, determining the prediction of motion of the display 109 in the based on the fusion of the received image data, the plurality of measurements of road excitations and the apriori data may include applying a neural network to predict motion of the display 109 based on road accelerations over time using the apriori data.

For example, applying the neural network may include stabilizer module 130 obtaining a confidence for the apriori data as a scaling factor, k, where high confidence results in a scale factor of 1 and a low confidence scale factor of 0 ignores the prediction of motion.

In one or more embodiments, stabilizer module 130 applies a limiting function to a maximum motion estimation to avoid erroneous edge data. As one of skill in the art will appreciated, a band pass filter or other appropriate filter applied to data over time will remove edge cases that do not reflect vibrations of interest. In one or more embodiments, prediction and motion can include choosing to limit the maximum motion estimate to avoid erroneous edge cases since these are estimates can account for network and display latency. For example, if a prediction of hitting a pothole in one second into the future can planned for, the stabilizer module 130 may adjust the display according to predicted vibration and may not suffer from a high latency penalties.

In one or more embodiments, the plurality of image data from sensors 150 includes captured camera images, captured driver state monitoring camera (DSMC) images and an estimate of a three-dimensional position of a driver or a passengers eyes. For example, if vehicle 102 includes a DSMC camera collecting video and three-dimensional data of passengers and drivers, the estimate of vibrations can be more accurate.

In one or more embodiments, stabilizer module 130 stores data and computationally transforms the stored data over time to minimize vibration on elements that affect viewability of the display. For example, displays 109 may vibrate at regular intervals depending on how a driver drives, location, and different recordable elements that can be stored in database 175 or database 230. The stored data may then be fused to form a prediction of motion of display 109.

This prediction of motion of display 109 may then be corrected in accordance with an embodiment based on different factors, such as the number of viewers of display 109.

In another embodiment, the prediction of motion of displays 109 includes applying a transformation matrix to the display based on the prediction of motion. The prediction of motion may include the sum or individual components of motion of display, driver head, and/or camera in translation, roll, pitch, and yaw (e.g. six degrees of freedom (DOF)). The prediction of motion may optionally be combined with the field of view of the driver and camera. Prediction of motion may be a global vehicle coordinate plane or relative to the camera, driver, or display. Given knowledge of present vehicle vibration, vehicle dynamics, vehicle motion plan (known or predicted), external road surface inputs (e.g. pot hole), the present vibration of the vehicle may be extrapolated into the future allowing for desired transformations such as filtering for viewability. The transformation matrix may include a neural network transformation that offsets the vibrations felt by the displays 109. For example, if a convolutional neural network with a transformation matrix indicates that the display will likely vibrate and a given frequency at a given time, the transformation matrix may apply the opposite digital type vibration or stabilization and that frequency at that time so that an observer would be unable to tell that there was any vibration at all. In another example, the displayed pixels and the image frame perspective (translation, pitch, roll, and yaw) may be warped or otherwise transformed dynamically to counteract the localized vibration of the camera, display, and/or viewer. The resulting image may “vibrate” in a local coordinate system but would appear stationary to another coordinate system that more strongly affects the viewability of the display such as the viewers’ or display.

In one or more embodiments, the transformation matrix to the display based on the prediction of motion of the display may include a temporal filtering to account for temporal motion of the image data tuned to a known response of the vehicle sensors to vehicle accelerations.

Referring back to FIG. 3, block 380 provides for receiving measurements from an accelerometer built into the display to measure accelerations that contribute to the prediction of motion of the display over time. For example, accelerometer 103 may provide data to stabilizer module 130 and if accelerometer 103 is built into each display to measure accelerations, stabilizer module 130 may be more accurate.

Block 390 provides for receiving vibration data from internal microphones or audio output from speaker systems in the vehicle as input data to predict motion of the display wherein the display motion is a function of the vibration data including audio output and vehicle accelerations. For example, data received by stabilizer module 130 may include sensors 150 that receive data from microphones, audio output, or speakers in vehicle 102. For example, if display 109 incorporates an accelerometer built into the display to measure accelerations that can be integrated into an estimation of motion of the display overtime the motion detected overtime may include music that is played in the vehicle. For example if a user likes to play dropped bass music or loud music with a predictable vibration pattern that vibration pattern can be subtracted from the display stabilization.

Prediction of motion of the display 109 in some embodiments includes a prediction of the motion of display based on prior driving. The method may also include capturing of camera images taken by the vehicle cameras are coupled to vehicle computer and may collect different data regarding shaking or image stabilization metrics.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, mobile devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving a plurality of image data from sensors in a vehicle;
receiving a plurality of measurements of road excitations from the sensors in the vehicle;
estimating a three-dimensional position of a eyes of a driver or passenger based on the plurality of image data;
receiving apriori data from high definition maps, recorded accelerations of the vehicle, and stored data via a controller area network (CAN) bus;
determining a prediction of motion of a display in the vehicle based on a fusion of the plurality of image data, the plurality of measurements of road excitations, and the apriori data; and
modeling the prediction of motion of the display in a convolutional neural network to form an initial estimate of a display stabilization position; and
displaying computationally corrected images on the display based on the display stabilization position and the three-dimensional position of the eyes of the driver of passenger.

2. The method of claim 1 wherein the determining the prediction of motion of the display in the vehicle based on the fusion of the plurality of image data, the plurality of measurements of road excitations and the apriori data further comprises:
applying a neural network to predict motion of the display based on road accelerations over time using the apriori data.

3. The method of claim 2 wherein applying the neural network for the prediction of motion of the display based on the road accelerations over time using the apriori data further comprises:
obtaining a confidence for the apriori data as a scaling factor, k, where high confidence results in a scale factor of 1 and a low confidence scale factor of 0 ignores the prediction of motion of the display.

4. The method of claim 1 wherein the determining the prediction of motion of the display in the vehicle further comprises:
applying a limiting function to a maximum motion estimation to avoid erroneous edge data.

5. The method of claim 1 wherein the plurality of image data includes captured camera images, captured driver state monitoring camera (DSMC) images, and the estimate of the three-dimensional position of the of the driver or passenger.

6. The method of claim 1, wherein receiving the apriori data from the high definition maps, the recorded accelerations of the vehicle, and the stored data via the CAN bus further comprises:
computationally transforming the stored data over time to minimize vibration on elements that affect viewability of the display.

7. The method of claim 1 wherein the determining the prediction of motion of the display in the vehicle based on the plurality of image data, the measurements of road excitations, and the apriori data further comprises:
fusing the prediction of motion of the display with prediction of motion of the sensors of the vehicle.

8. The method of claim 1 wherein the determining the prediction of motion of the display in the vehicle based on the plurality of image data, the measurements of road excitations, and the apriori data further comprises:
correcting the prediction of motion of the display based on a number of viewers of the display.

9. The method of claim 1 wherein the determining the prediction of motion of the display in the vehicle based on the plurality of image data, the measurements of road excitations, and the apriori data further comprises:
applying a transformation matrix to the display based on the prediction of motion of the display.

10. The method of claim 9 wherein applying the transformation matrix to the display based on the prediction of motion of the display further comprises:
applying a temporal filtering to account for temporal motion of the image data tuned to a known response of the sensors to vehicle accelerations.

11. The method of claim 1 further comprising:
receiving measurements from an accelerometer built into the display to measure accelerations that contribute to the prediction of motion of the display over time.

12. The method of claim 1 further comprising:
receiving vibration data from internal microphones or audio output from speaker systems in the vehicle as input data, wherein predicting the motion of the display is based on the vibrational data, and wherein the motion of the display is a function of the vibration data including the audio output and vehicle accelerations.

13. A system for a vehicle comprising:
a memory that stores computer-executable instructions;
a processor configured to access the memory and execute the computer-executable instructions to:
receive a plurality of image data from sensors in the vehicle;
receive a plurality of measurements of road excitations from the sensors in the vehicle;
estimate a three-dimensional position of a eyes of a driver or passenger based on the plurality of image data;
receive apriori data from high definition maps, recorded accelerations of the vehicle, and stored data via a controller area network (CAN) bus;
determine a prediction of motion of a display in the vehicle based on a fusion of the plurality of image data, the plurality of measurements of road excitations, and the apriori data;
model the prediction of motion of the display in a convolutional neural network to form an initial estimate of a display stabilization position; and
display computationally corrected images on the display based on the display stabilization position and the three-dimensional position of the eyes of the driver of passenger.

14. The system of claim 13 wherein the processor is configured to execute instructions to:
apply a neural network to predict motion of the display based on road accelerations over time using the apriori data; and
obtain a confidence for the apriori data as a scaling factor, k, where high confidence results in a scale factor of 1 and a low confidence scale factor of 0 ignores the prediction of motion.

15. The system of claim 13 wherein the processor is configured to execute instructions to:
computationally transform the stored data over time to minimize vibration on elements that affect viewability of the display.

16. The system of claim 13 wherein the processor configured to execute instructions to:
fuse the prediction of motion of the display with prediction of motion of the sensors of the vehicle.

17. The system of claim 13 wherein the processor configured to execute instructions to:
apply a transformation matrix to the display based on the prediction of motion of the display.

18. The system of claim 13 wherein the processor is further configured to execute instructions to:
receive measurements from an accelerometer built into the display to measure accelerations that contribute to the prediction of motion of the display over time.

19. The system of claim 13 wherein the processor is further configured to execute instructions to:
receive vibration data from internal microphones or audio output from speaker systems in the vehicle as input data to predict motion of the display, wherein the motion of the display is a function of the vibration data including the audio output and vehicle accelerations.

20. A vehicle comprising:
sensors coupled to the vehicle, the sensors including cameras and radar;
a processor coupled to a memory, the processor configured to access the memory and execute instructions to:
receive a plurality of image data from the sensors in the vehicle;
receive a plurality of measurements of road excitations from the sensors in the vehicle;
estimate a three-dimensional position of a eyes of a driver or passenger based on the plurality of image data;
receive apriori data from high definition maps, recorded accelerations of the vehicle, and stored data via a controller area network (CAN) bus;
applying a limiting function to a maximum motion estimation to avoid erroneous edge data;
determine a prediction of motion of a display in the vehicle based on a fusion of the plurality of image data, the plurality of measurements of road excitations and the apriori data;
applying a transformation matrix to the display based on the prediction of motion of the display;
applying a temporal filtering to account for temporal motion of the image data tuned to a known response of the sensors to vehicle accelerations;
model the prediction of motion of the display in a convolutional neural network to form an initial estimate of a display stabilization position; and
display computationally corrected images on the display based on the display stabilization position and the three-dimensional position of the eyes of the driver of passenger.
